(19) United States
(12) Patent Application Publication
(10) Pub. No.: US 2019/0330871 A1
(43) Pub. Date: Oct. 31, 2019

(54) DEVICE FOR DEMARCATING PARKING SPACES FOR MOTOR VEHICLES IN A COVERED SPACE

(71) Applicant: EURL HELIAGE, Carlus (FR)

(72) Inventor: Remi Grosset, Carlus (FR)

(21) Appl. No.: 16/462,053

(22) PCT Filed: Nov. 17, 2017
(86) PCT No.: PCT/FR2017/053150

§ 371 Date: May 17, 2019

(30) Foreign Application Priority Data
Nov. 18, 2016 (FR) 1661174

(51) Int. Cl. E04H 6/42; G09F 23/00; G09F 7/18

(52) U.S. Cl. CPC E04H 6/426; G09F 23/00; G09F 2007/1886; G09F 2007/1839; G09F 2007/186; G09F 7/18

(57) ABSTRACT

The invention relates to a device for longitudinally demarcating two parking spaces for motor vehicles in a covered space comprising: a flexible panel (20) extending in the longitudinal direction corresponding to the direction for parking vehicles on both sides of the device, and comprising an upper edge (22) and a lower edge (21); a plurality of linear elements (24) for suspending the flexible panel (20) distributed in the longitudinal direction and each comprising a first end (24a) suitable for being fixed to the ceiling of the covered space, and a second end (24b) connected to said upper edge (22) of said flexible panel (20); and a heavy tube (26) extending in the longitudinal direction and connected to said lower edge (21) of said flexible panel (20) in order to tension said flexible panel (20) under the effect of gravity.

### 1. TECHNICAL FIELD OF THE INVENTION

The technical field of the invention is that of devices for demarcating parking spaces. More specifically, the invention relates to a device for demarcating parking spaces for motor vehicles in a covered space, such as a car park, a garage, a ferry hold, and, generally, in any space having a ground surface intended to accommodate motor vehicles and a ceiling arranged facing the ground surface and extending above the parked vehicles.

### 2. TECHNOLOGICAL BACKGROUND

It is common practice to attempt to park motor vehicles in an organized and orderly manner in a limited space. This situation is mainly found in covered car parks, whether or not they are underground car parks, particularly in city center car parks, airport car parks, railway station car parks and, generally, in all public or private spaces exclusively dedicated for parking motor vehicles. Furthermore, the operators of these car parks attempt to optimize the positioning of the vehicles so as to be able to accommodate a maximum number of vehicles in a limited space. This situation is also encountered in vehicle transportation ferry holds, in which the pursuit of optimization of positioning is actively sought.

Organized and optimized positioning of motor vehicles in a covered space requires the demarcation of the parking spaces so that a driver of a vehicle can easily and quickly determine a predetermined and authorized parking space.

To this end, it is common practice for ground marking to be used to demarcate the parking spaces. Such a solution is simple and economical to implement. However, in practice it does not ensure proper observance of the ground markings and vehicles are often seen parked straddling the ground demarcation line, either due to driver negligence, or due to difficulty in correctly positioning the vehicle in relation to the marking during the parking maneuver.

Another solution that has already been proposed, particularly in ferry holds, involves providing guide rails on both sides of the parking spaces. Thus, a driver must drive their vehicle between two rails in order to reach a dedicated space. This solution has several disadvantages. In particular, it requires the installation of the guide rails, which is a long and expensive operation. In addition, the rails are irremovable and therefore do not allow the organization of the parking space to be changed if necessary. Finally, the maneuvers to be performed to access a parking space are complicated and can damage the vehicle if they are performed inexpertly.

Therefore, there is a need for a new solution for demarcating the parking spaces in a covered space, which optimizes the space available for parking, which facilitates the parking maneuvers for the drivers and which enhances the experience of parking in the covered space.

### 3. AIMS OF THE INVENTION

The invention aims to provide a device for demarcating parking spaces in a covered space that overcomes at least some of the disadvantages of the known prior solutions.

In particular, the invention aims to provide, in at least one embodiment, a demarcating device that facilitates the parking maneuver by a driver.

The invention also aims to provide, in at least one embodiment, a demarcating device that protects the vehicles parked on both sides of the device.

The invention also aims to provide, in at least one embodiment, a demarcating device that forms a communication space for information or advertising messages intended for users of the covered space.

The invention also aims to provide, in at least one embodiment of the invention, a removable demarcating device in order to be able to modify the arrangement of the parking spaces within the covered space without any major difficulties.

### 4. DISCLOSURE OF THE INVENTION

The invention relates to a device for demarcating two parking spaces of a covered space that is intended to be hung from the ceiling of the covered space and extends in a direction that shows the direction for parking vehicles. The device according to the invention comprises the technical features described hereafter that ensure proper retention of the device, facilitate its installation, and, according to advantageous embodiments, protect the vehicles parked on both sides of the device, and form a communication medium.

More specifically, the invention relates to a device for demarcating, in one direction, referred to as the longitudinal direction, two parking spaces for motor vehicles in a covered space having a ground surface intended to accommodate said vehicles and a ceiling facing the ground surface, said device being characterized in that it comprises:
a flexible panel extending in said longitudinal direction corresponding to the direction for parking vehicles on both sides of the device, and comprising an upper edge and a lower edge oriented toward the ceiling and the ground surface, respectively, when said device is fixed to the ceiling of the covered space, said flexible panel further comprising at least two distinct zones, including at least one display zone intended to accommodate a display medium and at least one perforated zone fulfilling a dual function as an air passage and as a visibility window;
a plurality of linear elements for suspending the flexible panel distributed in said longitudinal direction and each comprising a first end suitable for being fixed to said ceiling, and a second end connected to said upper edge of said flexible panel, so as to be able to keep said flexible panel longitudinally suspended between the two parking spaces to be demarcated;
a heavy tube extending in the longitudinal direction and connected to said lower edge of said flexible panel so as to tension said flexible panel under the effect of gravity.

A device according to the invention therefore makes it possible to realize two parking spaces for vehicles in a covered space. The device longitudinally demarcates the parking spaces. Also, a driver of a motor vehicle easily perceives the lateral limits of the parking space during a parking maneuver. This perception of the position of the parking space is particularly useful during a reversing maneuver, during which it is not always easy, with conventional demarcations, of the ground marking type, to perceive the position of the vehicle in relation to the marking. The risks of overlapping the space are therefore removed with a device according to the invention. A device according to the invention to a certain extent forms a flexible lateral wall of the parking space in which the vehicle must park.

In addition, the device according to the invention is easy to install in the covered space. The installation of the device according to the invention requires anchoring linear suspension elements in the ceiling at the division between the parking spaces intended for demarcation.

The flexible panel demarcates the parking spaces and does not hinder the movement of the vehicle in the event of mishandling due to its flexible and suspended character.

Finally, this flexible panel is held taut by the presence of a tube in the lower part of the device. Preferably, this heavy tube fully extends along the lower edge of the flexible panel so that it can evenly tension the flexible panel over the entire length of the flexible panel.

The cooperation of the flexible panel, the heavy tube connected to the lower edge of the panel and the linear suspension elements allows a demarcating device to be formed that is easy to handle, is flexible, is stable and that improves the parking experience of the users by facilitating the parking maneuvers. In addition, the device is removable so that a covered parking space can be reconfigured according to requirements without any particular problems.

Furthermore, the flexible panel comprises at least two distinct zones, including at least one display zone intended to accommodate a display medium and at least one perforated zone fulfilling a dual function as an air passage and as a visibility window.

The perforated zone allows air through in order to limit the wind load of the device. Such a device is therefore less sensitive to the wind and the air flow, which allows any swaying of the device to be limited. The cooperation of this perforated zone and the heavy tube allows a device to be formed that is stable and fairly insensitive to external disturbances. In addition, this perforated zone forms a visibility window, by which the driver or the passenger of a vehicle can see through the device. Such a zone therefore makes it possible to limit the effect of confinement or of possible claustrophobia caused by the presence of the demarcating device. In addition, this visibility window allows the driver to perceive their environment during the parking maneuver.

The demarcating device comprises not only a perforated zone limiting the wind load of the device, but also comprises a zone intended to accommodate a display medium. Such a display zone allows, for example, an advertising message or information to be displayed that is intended for the users of the car park in which the demarcating device is installed.

Advantageously and according to the invention, at least one display zone is configured to accommodate a flexible screen suitable for broadcasting multimedia content.

Advantageously and according to the invention, the heavy tube is made of a shock-absorbing material so as to be able to limit the effects of an impact resulting from the opening of a door of a motor vehicle parked alongside said device against a bodywork element of a motor vehicle parked on the other side of the device.

A demarcating device according to this advantageous embodiment not only allows a parking space to be demarcated, but also allows the vehicles parked on both sides of the device to be protected. In particular, a tube made of a shock-absorbing material, such as rubber, polystyrene, a flexible cellular plastics material, such as a foam, or any equivalent material, makes it possible to avoid an impact or a scratch on a door of a vehicle or of a lateral bodywork element of a vehicle that results from contact with a door of an adjacent vehicle when this door is opened. A device according to this embodiment therefore improves the experience of the users of the covered space in which the device is installed by protecting the vehicles that park there. Such a device therefore reduces the reluctance of some motorists to use covered car parks due to the regular impacts that are caused by the narrowness of the parking spaces.

Advantageously, a device according to the invention comprises three linear suspension elements evenly distributed along the upper edge of said flexible panel.

Advantageously and according to the invention, said linear suspension elements are wire or tubular and are length-adjustable so as to be able to adapt the suspension height of said flexible panel and the heavy tube above the ground surface.

The adjustable linear suspension elements allow the device according to this embodiment to be used in different spaces, irrespective of the ceiling height.

Advantageously and according to the invention, said flexible panel comprises at least one lateral edge extending between the upper edge and the lower edge, which has a portion of greater thickness relative to the rest of the flexible panel so as to form a visual indicator for a driver approaching a parking space demarcated by said device.

A device according to this embodiment facilitates the parking maneuver by a driver by providing an additional visual indicator of the demarcation zone of the parking space.

Advantageously and according to this variant, said lateral edge having a portion of greater thickness further comprises a reflective strip or a light device.

The reflective strip allows the lateral edge having a portion of greater thickness to be more apparent. The light device, such as light emitting diodes, also allows the lateral edge of the flexible panel to be revealed.

Advantageously and according to the invention, said upper edge of said flexible panel is formed by a rigid bar comprising means for anchoring said wire suspension elements.

Advantageously and according to the invention, said flexible panel is formed by one or more materials selected from the group comprising fabric, PVC type plastic and canvas.

The invention also relates to a device for demarcating parking spaces characterized, in combination, by all or some of the features mentioned above or hereafter.

### 5. LIST OF FIGURES

Further aims, features and advantages of the invention will become apparent upon reading the following description, which is provided solely by way of a non-limiting example, and which refers to the appended figures, in which:

FIG. 1 is a schematic perspective view of a covered space equipped with three devices for demarcating parking spaces for motor vehicles according to one embodiment of the invention;

FIG. 2 is a schematic perspective view of a device for demarcating parking spaces for motor vehicles according to one embodiment of the invention;

FIG. 3 is a schematic front view of two motor vehicles parked on either side of a demarcating device according to one embodiment of the invention;

FIG. 4 shows the same configuration as that of FIG. 3, in which one of the vehicles has an open door that comes into abutment against the demarcating device according to one embodiment of the invention;

FIG. 5 is a side view of a motor vehicle parked behind a demarcating device according to one embodiment of the invention.

### 6. DETAILED DESCRIPTION OF ONE EMBODIMENT OF THE INVENTION

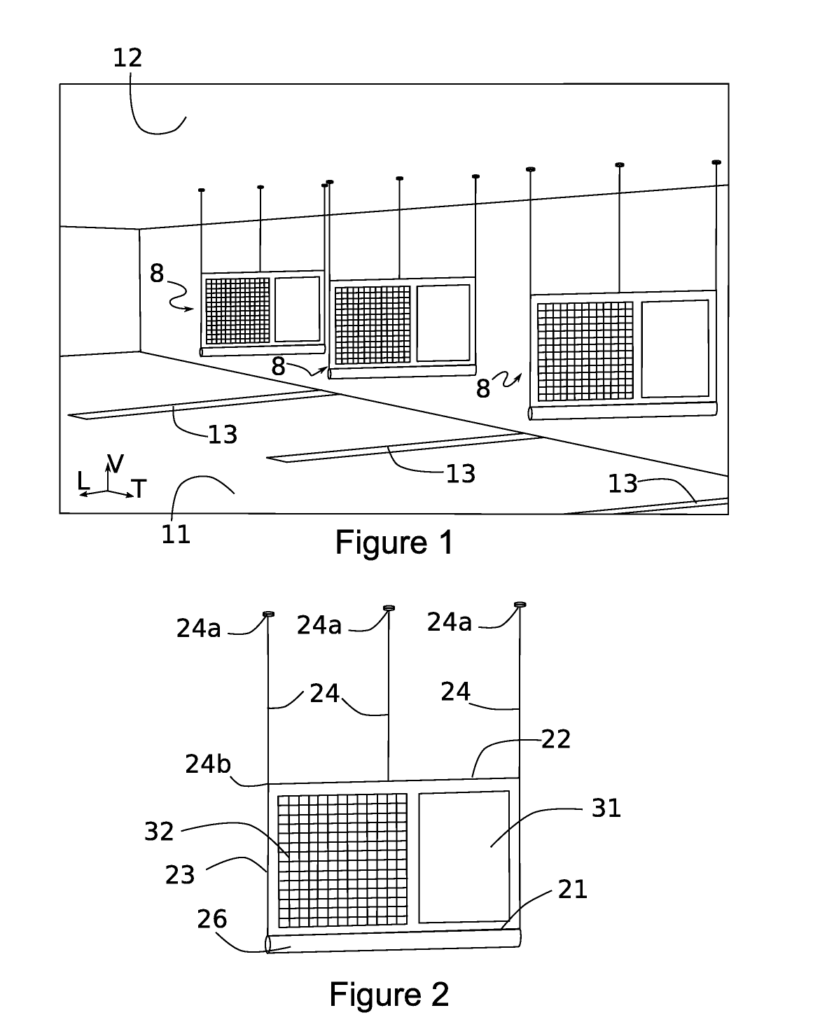

Scales and proportions are not strictly adhered to in the figures for the sake of illustration and clarity. Throughout the following detailed description with reference to the figures, unless otherwise indicated, each element of the device for demarcating two parking spaces for motor vehicles in a covered space is described as it is arranged when the device is anchored to the ceiling of a covered space, such as a car park. This arrangement is shown in particular in FIGS. 1, 3, 4 and 5.

In addition, identical, similar or analogous elements are denoted using the same reference signs in all the figures. Finally, the terms longitudinal, transverse and vertical are used in a non-limiting manner with reference to the trihedron L, T, V, as shown in FIG. 1. The longitudinal direction corresponds to the main direction of the demarcating device and defines the direction for parking motor vehicles on both sides of the device. The vertical direction is the direction defined by gravity. The transverse direction is the direction perpendicular to the longitudinal direction and to the vertical direction.

FIG. 1 represents a covered space comprising a ground surface 11 intended to accommodate vehicles and a ceiling 12, facing the ground surface 11.

This covered space is equipped with three demarcating devices 8 according to one embodiment of the invention. These demarcating devices 8 define parking spaces for motor vehicles, not shown in FIG. 1.

In FIG. 1, ground markings 13 are also present at the site of the demarcating devices in order to form a reminder of the parking spaces demarcated by the devices according to the invention.

As shown in FIG. 2, a demarcating device comprises a flexible panel 20 extending in the longitudinal direction. This flexible panel 20 comprises an upper edge 22 and a lower edge 21 oriented toward the ceiling 12 and the ground surface 11, respectively, once the device is fixed to the ceiling 12.

The device also comprises three linear elements for suspending the flexible panel 20 that are distributed in the longitudinal direction. These linear elements are formed, in the embodiment of the figures, by wire ropes 24. According to other embodiments, the linear suspension elements are ropes, straps or any equivalent means.

Each linear suspension element comprises a first end 24a, hereafter referred to as the upper end 24a, suitable for being fixed to the ceiling 12, and a second end 24b, hereafter referred to as the lower end 24b, connected to the upper edge 22 of the flexible panel 20. The upper end 24a is formed, for example, by a ring intended to engage with a hook anchored in the ceiling 12. The lower end 24b is, for example, a screw suitable for engaging with a thread provided in a rigid bar forming the upper edge 22 of the flexible panel 20. According to another embodiment, the lower end 24b is a lifting hook that engages with a half-ring rigidly connected to the upper edge 22 of the flexible panel 20. According to another embodiment, the lower end 24b is adhered to the upper edge 22 or is assembled using any equivalent means.

The device according to the invention also comprises a heavy tube 26 extending along the lower edge 21 of the flexible panel 20 in order to tension the flexible panel 20 under the effect of gravity. The primary function of this heavy tube 26 is to tension the flexible panel 20 by exerting a tensile force on the flexible panel 20 under the effect of natural gravity. This combination of the flexible panel 20 and the heavy tube 26 allows a taut flexible panel to be obtained, which forms a straight demarcation of the parking space and allows any damage of an outside rear-view mirror of a car to be avoided in the event of contact with the flexible panel during a parking maneuver. In the event of contact, the outside rear-view mirror slides over the flexible panel and deforms said panel without the outside rear-view mirror experiencing any damaging contact, which would be the case with a rigid panel.

According to one embodiment, which is not shown in the figures, the device can further comprise one or more tensioning lines, each comprising an end connected to the heavy tube or to the lower edge of the flexible panel to which the heavy tube is itself connected, and an opposite end anchored to the ground surface. These lines thus allow, in combination with the heavy tube, the flexible panel to be tensioned and any swaying of the demarcating device to be avoided, for example, in a car park with significant air currents.

According to the preferred embodiment of the invention, and as shown in the figures, the heavy tube is made of a shock-absorbing material in order to be able to limit the effects of an impact resulting from the opening of a door of a motor vehicle parked alongside the device against a bodywork element of a motor vehicle parked on the other side of the device. The material used to form the heavy tube is, for example, rubber, polystyrene, or a flexible cellular plastics material, such as a foam.

According to one embodiment, the heavy tube is arranged in a sheath forming the lower edge of the flexible panel. According to another embodiment, the heavy tube is adhered to the lower edge of the flexible panel or is assembled to the lower edge by any equivalent means.

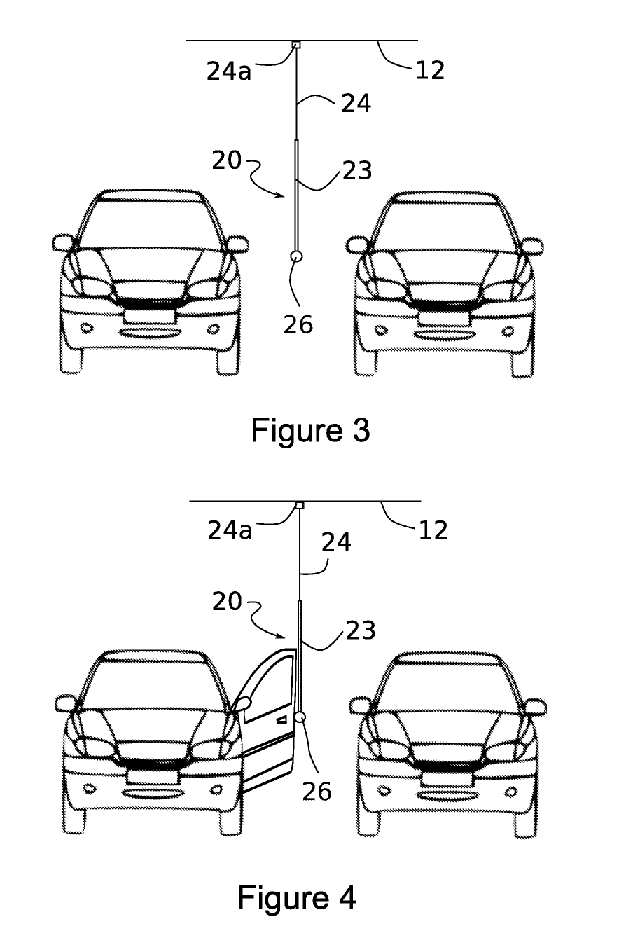

FIGS. 3 and 4 illustrate the role of a heavy tube 26 made of a shock-absorbing material.

In FIG. 3, two vehicles are parked on either side of the parking space demarcating device 8 according to this embodiment of the invention.

In FIG. 4, the car on the left of the figure has its door open. The opening of the door is restricted by the heavy tube 26, which absorbs the inertia of the opening of the door and prevents direct mechanical contact with the vehicle parked on the other side of the demarcating device. If the vehicles are parked close to each other, the shock-absorbing device can come into contact with the adjacent car, yet without causing mechanical damage or scratching on the vehicle body because of its absorption capacity.

In this embodiment, the linear suspension elements are preferably adjustable in order to be able to ensure that, during the installation of the demarcating device, the heavy shock-absorbing tube is maintained at a height from the ground surface that corresponds to optimum protection of the doors of vehicles. In practice, this height is between 50 centimeters and 110 centimeters from the ground surface.

In FIGS. 3 and 4, it can also be seen that the flexible panel 20 has a lateral edge 23 having a portion of greater thickness relative to the rest of the flexible panel 20 in order to provide the driver with an additional visual indicator of the demarcation zone of the parking space. This lateral edge 23 can, for example, comprise a reflective strip for improving the visual comfort of the driver, including in low light. According to another embodiment of the invention, the flexible panel has a portion of greater thickness on each of its lateral edges for facilitating parking maneuvers in spaces in the central rows of the covered space.

In addition, and according to the embodiment of the figures, the flexible panel 20 comprises two distinct zones, a display zone 31 intended to accommodate a display medium and a perforated zone 32 fulfilling a dual function as an air passage and as a visibility window.

A perforated zone 32 allows air to pass through so that the demarcating device does not sway under the effect of air currents. In addition, this perforated zone 32 allows vision through the demarcating device, which provides reassurance in enclosed spaces such as car parks.

A display zone 31 forms a medium for an advertising message or an information message intended for drivers or passengers of motor vehicles.

According to the embodiment of the figures, the flexible panel is 100 cm high and 200 cm long, and the display zone allows a document to be displayed in the format known as A1 (594 mm×841 mm). Of course, other dimensions can be implemented without changing the scope and purpose of the invention.

The display zone 31 is, according to one embodiment of the invention, formed by a translucent PVC double skin configured to accommodate, between the two walls of the double skin, an advertising poster or information intended for the public. This double skin comprises a lateral opening provided, for example, with Velcro® type assembly means or any equivalent means allowing an operator to open/close the access to the double skin to insert/remove an advertising poster or equivalent document. According to another embodiment, the display zone 31 is formed by a printed canvas.

According to another variant, the display zone is configured to accommodate a flexible screen suitable for broadcasting multimedia content.

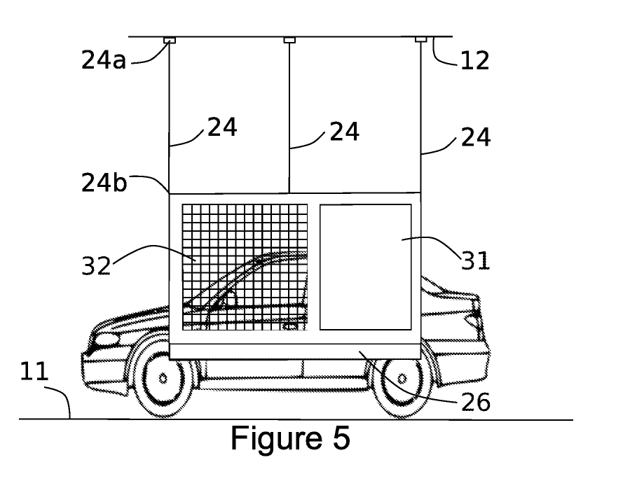

FIG. 5 is a view of a demarcating device according to one embodiment of the invention, which shows the perforated zone 32, through which the vehicle can be seen parked alongside the device.

In the embodiment of FIG. 1, the demarcating devices are fixed to the ceiling 12 so that the perforated zones 32 are arranged at the front of the device and the display zones 31 are arranged at the rear of the device, considering the rear wall of the enclosed space as the rear.

According to another assembly variant, the demarcating device can be arranged so that the advertising message is arranged at the front of the device. This reverse installation prevents the driver from being hindered during their parking maneuver by allowing them to better see the rear side environment through the perforated zone of the demarcating device. In addition, the advertising message being positioned at the front allows pedestrians walking in the covered space to have a quick and easy view of the message displayed in the display zone. The assembly and fixing of the device according to the invention depends on the intended aim and on the configuration of the sites.

According to a variant that is not shown in the figures, the demarcating device further comprises means for supplying electric power for recharging the batteries of electric vehicles. For example, the heavy tube is equipped with one or more power sockets arranged at the longitudinal ends of the tube and connected to the mains power supply of the covered space in which the demarcating device is arranged, via electrical cables running alongside the lateral edges of the flexible panel and the wire suspension elements or inserted into these wire elements, and emerging on the ceiling toward electrical relays of the covered space. Of course, other means for routing electric power to the power supply sockets provided on the heavy tube can be provided. Similarly, the arrangement of the power sockets on the heavy tube can be provided elsewhere on the demarcating device without any major problems. With this being the case, an arrangement on the heavy tube helps, due to the weight of the electric power sockets, the flexible panel to be held taut by the heavy tube.

The invention is not limited to only the embodiments described with reference to the figures. For example, according to other embodiments that are not shown, the flexible panel comprises only one perforated zone that occupies the whole of the flexible panel. According to other variants, the panel comprises a plurality of perforated zones that may or may not be separated by display zones. Finally, according to other variants, one or more display zones occupy the whole of the flexible panel.

1. A device for demarcating, in a longitudinal direction, two parking spaces for motor vehicles in a covered space having a ground surface intended to accommodate said vehicles and a ceiling facing the ground surface, said device comprising:
a flexible panel extending in said longitudinal direction corresponding to the direction for parking vehicles on both sides of the device, and comprising an upper edge and a lower edge oriented toward the ceiling and the ground surface, respectively, when said device is fixed to the ceiling of the covered space, said flexible panel further comprising at least two distinct zones, including at least one display zone intended to accommodate a display medium and at least one perforated zone fulfilling a dual function as an air passage and as a visibility window;
a plurality of linear elements for suspending the flexible panel distributed in said longitudinal direction and each comprising a first end suitable for being fixed to said ceiling, and a second end connected to said upper edge of said flexible panel, so as to be able to keep said flexible panel longitudinally suspended between the two parking spaces to be demarcated;
a heavy tube extending in the longitudinal direction and connected to said lower edge of said flexible panel so as to tension said flexible panel under the effect of gravity.

2. The device according to claim 1, characterized in that at least one display zone is configured to accommodate a flexible screen suitable for broadcasting multimedia content.

3. The device according to claim 1, wherein said heavy tube is made of a shock-absorbing material so as to be able to limit the effects of an impact resulting from the opening of a door of a motor vehicle parked alongside said device against a bodywork element of a motor vehicle parked on the other side of the device.

4. The device according to claim 1, wherein it comprises three linear suspension elements evenly distributed along the upper edge of said flexible panel.

5. The device according to claim 1, wherein said linear suspension elements are wire or tubular and are length-adjustable so as to be able to adapt the suspension height of said flexible panel above the ground surface.

6. The device according to any of claim 1, wherein said flexible panel comprises at least one lateral edge extending between the upper edge and the lower edge, which has a portion of greater thickness relative to the rest of the flexible panel so as to form a visual indicator for a driver approaching a parking space demarcated by said device.

7. The device according to claim 6, wherein said lateral edge having a portion of greater thickness further comprises a reflective strip or a light device.

8. The device according to claim 1, wherein said upper edge of said flexible panel is formed by a rigid bar comprising means for anchoring said wire suspension elements.

9. The device according to claim 1, wherein said flexible panel is formed by one or more materials selected from the group comprising fabric, PVC type plastic and canvas.
